(19) United States
(12) Patent Application Publication
(10) Pub. No.: US 2006/0023646 A1
(43) Pub. Date: Feb. 2, 2006

(54) Method and apparatus for anonymous data transfers

(76) Inventors: David A. George, Somers, NY (US); Raymond B. Jennings III, Ossining, NY (US); Jason D. Lavoie, Mahopac, NY (US); Sambit Sahu, Mahopac, NY (US)

Correspondence Address: Moser, Patterson & Sheridan, Suite 100, 595 Shrewsbury Avenue, Shrewsbury, NJ, 07702, US

(21) Appl. No.: 10/909,024

(22) Filed: Jul. 30, 2004

(51) Int. Cl. H04L 12/28

(52) U.S. Cl. 370/282; 370/400

(57) ABSTRACT

One embodiment of the present method and apparatus for anonymous data transfers comprises connecting first and second network endpoints to at least one relay node and transferring data from the first endpoint to the second endpoint through the at least one relay node such that the first and second endpoints are not aware of each other's identities, e.g., are not aware of an ultimate source or destination of transferred data. In further embodiments, an information field specifying a number of times that a data transfer message (e.g., a request, response or get message) should be forwarded is altered so that no receiving node can inferentially identify an originating node.

### CROSS REFERENCE TO RELATED APPLICATIONS

The present invention is related to U.S. patent application No. ______, filed concurrently herewith (Docket No. YOR920040322US1).

### BACKGROUND

The present invention relates generally to computing networks and relates more particularly to anonymous data transfers between computing devices.

FIG. 1 is a schematic diagram of a network 100 of nodes (e.g., computing devices) interacting in a peer-to-peer (P2P) manner. Generally, a requesting node 101 sends a search message 105 (e.g., containing keywords relating to data that the requesting node 101 wishes to locate) to one or more intermediate network nodes 111 connected to the requesting node 101. Each intermediate node 111 receives the search message 105 and then forwards the search message 105 to one or more additional nodes 111. Eventually, the search message 105 reaches one or more responding nodes 103 having the requested data. One or more responding nodes 103 then send a response message 107 back to the requesting node 101, e.g., via the intermediate nodes 111. The requesting node 101 then requests the relevant data from a responding node 103 by connecting directly to the responding node 103, e.g., via direct connection 109.

In conventional P2P systems, both the requesting node 101 and the responding node 103 are aware of the other's identity such that one node has some unique information about the other node (e.g., a network address). Intermediate nodes may likewise be aware of the identities of the requesting node 101 and/or the responding node 103, depending on what type of identification is contained within the search and response messages 105 and 107. Conventional anonymous transfer methods, such as static anonymizing services, may be easily compromised, revealing the identities of transferring parties and/or causing a denial of service. Other methods for preserving the identity of the transferring parties typically involve encrypting the transferred files such that their contents are unknown. However, searching content using standard text for file names becomes impractical, and users typically must know specific public keys for desired data, making key distribution a network bottleneck.

Thus, there is a need in the art for a method and apparatus for anonymous data transfers.

### SUMMARY OF THE INVENTION

One embodiment of the present method and apparatus for anonymous data transfers comprises connecting first and second network endpoints to at least one relay node and transferring data from the first endpoint to the second endpoint through the at least one relay node such that the first and second endpoints are not aware of each other's identities, e.g., are not aware of an ultimate source or destination of transferred data. In further embodiments, an information field specifying a number of times that a data transfer message (e.g., a request, response or get message) should be forwarded is altered so that no receiving node can inferentially identify an originating node.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a network of nodes interacting in a peer-to-peer manner;

FIG. 2 is a flow diagram illustrating one embodiment of a method for anonymously transferring data according to the present invention;

FIG. 3 is a flow diagram of one embodiment of a method for anonymizing a message sent through a computing network; and

FIG. 4 is a high level block diagram of the data transfer anonymizing method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for anonymous data transfers. Embodiments of the present invention enable data to be transferred between two or more endpoints in a manner that maintains the anonymity of one or more of the transfer endpoints relative to the other, without the need for complicated encryption methods or static nodes. Thus, the anonymity of transferring parties is maintained without compromising system security or efficiency.

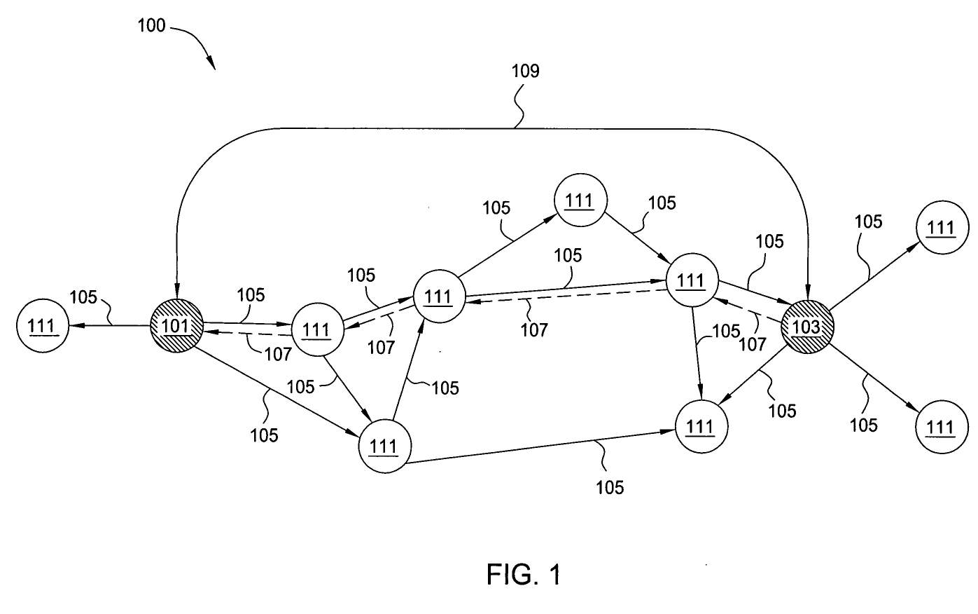

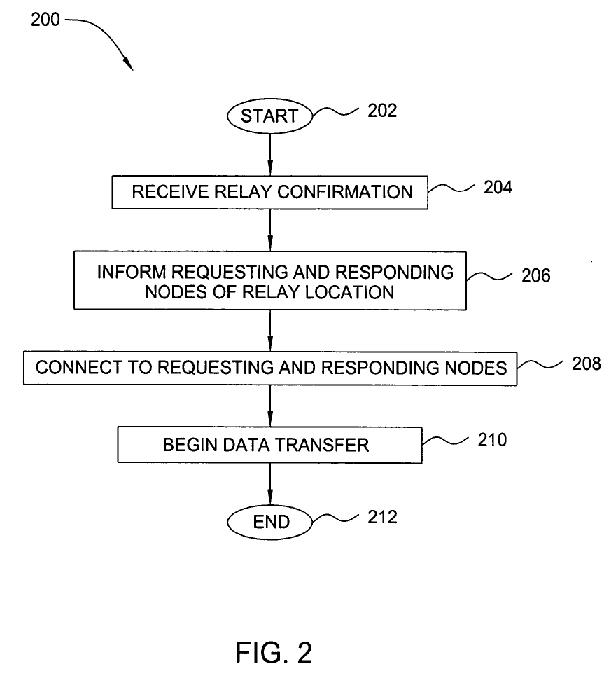

FIG. 2 is a flow diagram illustrating one embodiment of a method 200 for anonymously transferring data according to the present invention. In one embodiment, the method 200 is deployed within a conventional P2P system such as the network 100 illustrated in FIG. 1. In one embodiment, the method 200 is executed at an intermediate node, e.g., a node 111.

The method 200 is initialized at step 202 and proceeds to step 204, where the method 200 receives confirmation to initiate a data transfer using a specified node (e.g., a “relay node”) as a relay point between the requesting node and the responding node, e.g., in place of a direct connection between the requesting and responding nodes (such as connection 109). In one embodiment, a relay node is selected using an election process (e.g., based on probability and other attributes) as described in further detail below.

In step 206, the method 200 informs the requesting and responding nodes (e.g., nodes 101 and 103) of the location of the relay node. In one embodiment, this is accomplished by sending connect messages from the relay node to the requesting and responding nodes. A connect message instructs the receiving node (e.g., a requesting or responding node) to connect to the relay node. In one embodiment, a connect message includes the network address and port number of the relay node.

In one embodiment, the method 200 sends connect messages to the requesting and responding nodes instructing both the requesting and responding nodes to connect to a common relay node. In another embodiment, the method 200 sends different connect messages to the requesting and responding nodes, e.g., instructing the requesting node to connect to a first relay node and instructing the responding node to connect to a second relay node. In this case, the method 200 will also send a connect message to the second relay node, asking the second relay node to connect to the first relay node. Thus, the responding node will send the requested data to the second relay node, which will send the requested data to the first relay node, which is connected to the requesting node. The second relay node will regard the first relay node as the requesting node (e.g., the node at which the data transfer request was initiated).

In step 208, the method 200 connects the relay node(s) to the requesting node and to the responding node. The method 200 then initiates a data transfer in step 210, e.g., so that the responding node first transfers the requested data to the relay node, and the relay node then transfers the requested data to the requesting node. Once the data transfer is complete, the method 200 terminates in step 212.

Thus, the method 200 enables a data transfer in which the endpoints of the transfer (e.g., the requesting and responding nodes 101 and 103) are anonymous to each other. That is, a relay node may know both the requesting node and the responding node, but the requesting node will view the relay node as the responder, and the responding node will view the relay node as the requestor. Alternatively, where multiple relay nodes are employed to transfer data from the responding node to the requesting node, a relay node may know the identity of only the requesting node, only the responding node, or only other relay nodes. Thus, the identities of the requesting and responding nodes remain substantially anonymous.

In one embodiment, the one or more relay nodes at which data transfer occurs (e.g., in accordance with step 210 of the method 200) are selected when the requesting node sends a “get message” request through the network to the responding node, e.g., in answer to a response message indicating that the responding node has the data for which the requesting node is looking. In one embodiment, the “get message” request travels through the network along the same path that the response message traveled. In one embodiment, as each intermediate node along that path receives and forwards the “get message” request, the intermediate node also chooses or is assigned a number corresponding to a probability that the intermediate node will become the relay node when the method 200 is initiated. In one embodiment, the numbers corresponding to the probabilities are chosen arbitrarily. In another embodiment, the probability increases with each subsequent intermediate node to which the “get message” request is forwarded. In another embodiment, the probability is influenced by at least one intermediate node or network parameter, including, but not limited to, downstream bandwidth, upstream bandwidth, downstream latency, upstream latency, central processing unit (CPU) utilization, CPU cycle time, an amount of total or free memory at the intermediate node, a number of open connections, a number of network cards, a number of IP addresses per network card and the like.

In one embodiment, the relay node is selected when the responding node sends the response message to the requesting node, e.g., indicating that the responding node has the data for which the requesting node is looking. In one embodiment, as each intermediate node along the transmission path of the response message receives and forwards the response message, the intermediate node also chooses or is assigned a number corresponding to a probability that the intermediate node will become the relay node when the method 200 is initiated. In one embodiment, probability is selected or assigned in accordance with any of the methods described above.

In one embodiment, as each intermediate node forwards the response message, the intermediate node includes its own network address as the next point of contact. Thus, when the requesting and responding nodes ultimately connect to the selected relay node to initiate data transfer (e.g., in accordance with step 210 of the method 200), the relay node sees the responding node as simply the next contact node and does not recognize the responding node as the responder. When the requesting node receives the response message, the response message indicates the network address of the intermediate node that has been selected as the relay node.

In one embodiment, the selected relay node may be either the requesting node or the responding node. For example, the selected relay node may be the requesting node, in which case the responding node would not be aware of the fact that the relay node to which it connects is the requesting node. From the responding node's perspective, the relay node to which it connects is an arbitrary intermediate node. If the relay node is selected during the transmission of the response message, the requesting node will likewise view the responding node as an arbitrary next contact node. Thus, the requesting and responding nodes remain anonymous.

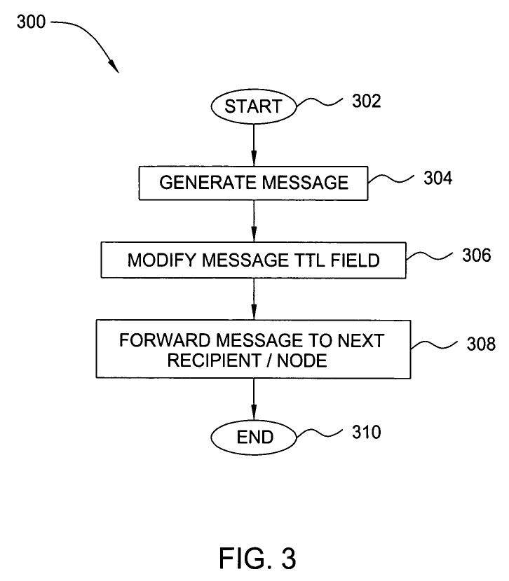

FIG. 3 is a flow diagram of one embodiment of a method 300 for anonymizing a message (e.g., a request message, a response message or a “get message” request”) sent through a computing network (e.g., network 100). In one embodiment, at least one of the request message, the response message and the “get message” request is altered in accordance with the method 300 to enhance the anonymity of data transfers through the network.

The method 300 is initialized at step 302 and proceeds to step 304, where the method 300 generates a message (e.g., a request message, a response message or a “get message” request) for transmission through a computing network. In one embodiment, messages generated in step 304 exclude any personal identification that would enable another node in the network to identify the node at which the messages originated. For example, in one embodiment, rather than include a network address for the originating node, the message includes a globally unique random number (GUID) as the identifier for a particular message. Every node (e.g., intermediate or responding node) to which the message is subsequently forwarded will maintain a list or mapping of the connection over which the message with the GUID was received in accordance with standard P2P procedures, e.g., so the messages responding to the original message may be forwarded over the same connection and in the direction of the originating node.

In step 306, the method 300 modifies the “time to live” (TTL) field of the message, or the field indicating how many times the generated message should be forwarded to other nodes in the network before the message is discarded. Typically, the TTL field either increases to a specified maximum value or decreases to a specified minimum value (e.g., zero) as it is forwarded through the network. For example, in a typical network, a requesting node may generate a request message having a TTL field that starts at “10” and decreases by one unit with each node to which it is forwarded. Thus, once the request message has been forwarded to the tenth node, it is discarded. A drawback of such forwarding mechanisms is that any node that is connected to the requesting node can infer that the node from which it received the message is the requesting node, because the value in the TTL field will be undiminished (i.e., because the connected nodes are the first nodes to which the message is forwarded).

Thus, in step 306, the method 300 modifies the TTL field of the message generated in step 304 by either adding or subtracting an arbitrary amount from the default starting value. In one embodiment, the added or subtracted amount is small relative to the default value. The method 300 then forwards the message (with the modified TTL field) to the next node in the data transfer stream in step 308. In step 310, the message 310 terminates.

The method 300 may be implemented both at a requesting node and at a receiving node. That is, a requesting node may generate and forward an anonymous request message through the network in accordance with the method 300 (e.g., where the anonymous request message will eventually be received by a responding node). As the anonymous request message is forwarded through the network, each intermediate node that receives the anonymous request message maintains a mapping of message identifiers to the adjacent node (e.g., from which the forwarded message was received). When the responding node generates a corresponding anonymous response message, a second arbitrary value (which may or may not be equal to the first arbitrary value) is inserted in the TTL field of the anonymous request message, and the intermediate nodes forward the anonymous response message back to the requesting node in accordance with the information stored in each intermediate node's message identifier mapping. Just as the intermediate and responding nodes will not be able to infer that the anonymous request message originated at the requesting node, the intermediate and requesting nodes will not be able to infer that the anonymous response message originated at the responding node.

Because the method 300 modifies the TTL field by an arbitrary value, it is substantially more difficult for any node receiving a message from another node to infer at which node the message originated. Thus, the node at which the message was generated (e.g., a requesting node or a responding node) remains substantially untraceable and anonymous. Although the method 300 is described here as being implemented in conjunction with the method 200 (in order to enhance anonymity of data transfers made in accordance with the method 200), it will be understood that the method 300 may be implemented independent of the method 200, e.g., as part of any data transfer method.

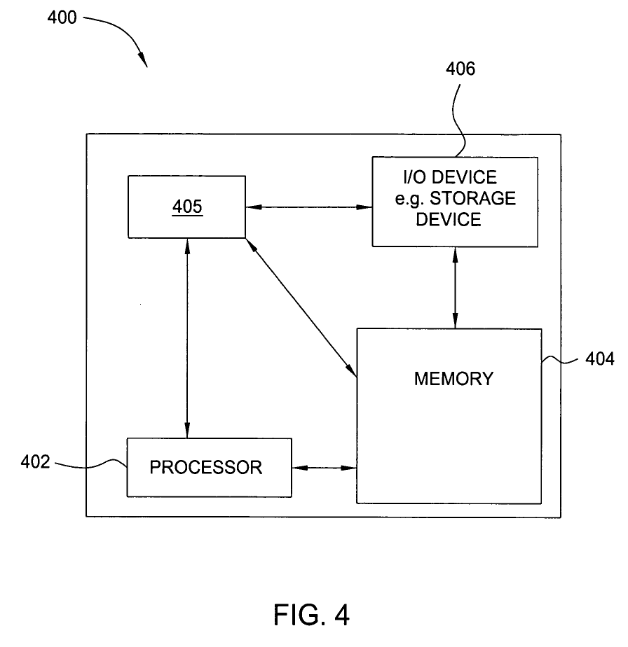

FIG. 4 is a high level block diagram of the data transfer anonymizing method that is implemented using a general purpose computing device 400. In one embodiment, a general purpose computing device 400 comprises a processor 402, a memory 404, an anonymizing module 405 and various input/output (I/O) devices 406 such as a display, a keyboard, a mouse, a modem, and the like. In one embodiment, at least one I/O device is a storage device (e.g., a disk drive, an optical disk drive, a floppy disk drive). It should be understood that the anonymizing module 405 can be implemented as a physical device or subsystem that is coupled to a processor through a communication channel.

Alternatively, the anonymizing module 405 can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the anonymizing module 405 for detecting leaks described herein with reference to the preceding Figures can be stored on a computer readable medium or carrier (e.g., RAM, magnetic or optical drive or diskette, and the like).

Thus, the present invention represents a significant advancement in the field of data transfer systems. A method and apparatus are provided that enable data to be transferred between two or more endpoints in a manner that maintains the anonymity of one or more of the transfer endpoints relative to the other. Moreover, because the invention is not static and does not require complicated encryption methods, it enables simplified searching methods and is very difficult to compromise. Thus, the anonymity of transferring parties is maintained without compromising system security or efficiency.

While foregoing is directed to the preferred embodiment of the present invention, other and further embodiments of the invention may be devised without departing from the basic scope thereof, and the scope thereof is determined by the claims that follow.

1. A method for transferring data from a first endpoint to a second endpoint in a network, said method comprising the steps of:
connecting said first and second endpoints to at least one relay node in said network; and
transferring data from said first endpoint to said second endpoint through said at least one relay node such that said first and second endpoints are not aware of an ultimate source or destination of said transferred data.

2. The method of claim 1, wherein said at least one relay node is one of the first or the second endpoint.

3. The method of claim 1, wherein said at least one relay node is an intermediate network node located between said first and second endpoints on a network path.

4. The method of claim 1, wherein said at least one relay node is selected by:
sending a get message request through said network from said second endpoint to said first endpoint in order to confirm that said second endpoint wishes to acquire data residing at said first endpoint, where said get message request is forwarded to one or more intermediate nodes before being received by said first endpoint; and
assigning a probability to said first and second endpoints and to each intermediate node that receives said get message request, where said probability represents a likelihood that said first endpoint, said second endpoint or said intermediate node will become said at least one relay node.

5. The method of claim 4, wherein said probability is based on at least one of the following parameters: bandwidth downstream of said at least one relay node, bandwidth upstream of said at least one relay node, latency upstream of said at least one relay node, latency downstream of said at least one relay node, central processing unit utilization, central processing unit cycle time, amount of total memory at said relay node, amount of available memory at said relay node, a number of open network connections, a number of network interface cards, and a number of network addresses per network interface card.

6. The method of claim 4, wherein said probability increases with each subsequent intermediate node or endpoint to which said get message request is sent.

7. The method of claim 1, wherein said at least one relay node is selected by:
sending a response message through said network from said first endpoint to said second endpoint in order to confirm that said first endpoint has data that said second end point requests, where said response message is forwarded to one or more intermediate nodes before being received by said second endpoint; and
assigning a probability to said first and second endpoints and to each intermediate node that receives said response message, where said probability represents a likelihood that said first endpoint, said second endpoint or said intermediate node will become said at least one relay node.

8. The method of claim 7, wherein said probability is based on at least one of the following parameters: bandwidth downstream of said at least one relay node, bandwidth upstream of said at least one relay node, latency upstream of said at least one relay node, latency downstream of said at least one relay node, central processing unit utilization, central processing unit cycle time, amount of total memory at said relay node, amount of available memory at said relay node, a number of open network connections, a number of network interface cards, and a number of network addresses per network interface card.

9. The method of claim 7, wherein said probability increases with each subsequent intermediate node or endpoint to which said response message is sent.

10. The method of claim 1, wherein said connecting step comprising:
connecting said first endpoint to a first relay node; and
connecting said second endpoint to a second relay node.

11. The method of claim 10, further comprising:
connecting said first relay node directly to said second relay node.

12. The method of claim 10, further comprising:
connecting said first relay node indirectly to said second relay node via one or more additional relay nodes.

13. The method of claim 1, wherein said transferring step comprises:
generating a message at at least one of said first or second endpoints for delivery through said network; and
modifying a default value in said message's time to live field by an arbitrary amount, such that intermediate nodes or endpoints receiving said message can not infer a source of said message.

14. A computer readable medium containing an executable program for transferring data from a first endpoint to a second endpoint in a network, where the program performs the steps of:
connecting said first and second endpoints to at least one relay node in said network; and
transferring data from said first endpoint to said second endpoint through said at least one relay node such that said first and second endpoints are not aware of an ultimate source or destination of said transferred data.

15. The computer readable medium of claim 14, wherein said at least one relay node is one of the first or the second endpoint.

16. The computer readable medium of claim 14, wherein said at least one relay node is an intermediate network node located between said first and second endpoints on a network path.

17. The computer readable medium of claim 14, wherein said at least one relay node is selected by:
sending a get message request through said network from said second endpoint to said first endpoint in order to confirm that said second endpoint wishes to acquire data residing at said first endpoint, where said get message request is forwarded to one or more intermediate nodes before being received by said first endpoint; and
assigning a probability to said first and second endpoints and to each intermediate node that receives said get message request, where said probability represents a likelihood that said first endpoint, said second endpoint or said intermediate node will become said at least one relay node.

18. The computer readable medium of claim 17, wherein said probability is based on at least one of the following parameters: bandwidth downstream of said at least one relay node, bandwidth upstream of said at least one relay node, latency upstream of said at least one relay node, latency downstream of said at least one relay node, central processing unit utilization, central processing unit cycle time, amount of total memory at said relay node, amount of available memory at said relay node, a number of open network connections, a number of network interface cards, and a number of network addresses per network interface card.

19. The computer readable medium of claim 17, wherein said probability increases with each subsequent intermediate node or endpoint to which said get message request is sent.

20. The computer readable medium of claim 14, wherein said at least one relay node is selected by:
sending a response message through said network from said first endpoint to said second endpoint in order to confirm that said first endpoint has data that said second end point requests, where said response message is forwarded to one or more intermediate nodes before being received by said second endpoint; and
assigning a probability to said first and second endpoints and to each intermediate node that receives said response message, where said probability represents a likelihood that said first endpoint, said second endpoint or said intermediate node will become said at least one relay node.

21. The computer readable medium of claim 20, wherein said probability is based on at least one of the following parameters: bandwidth downstream of said at least one relay node, bandwidth upstream of said at least one relay node, latency upstream of said at least one relay node, latency downstream of said at least one relay node, central processing unit utilization, central processing unit cycle time, amount of total memory at said relay node, amount of available memory at said relay node, a number of open network connections, a number of network interface cards, and a number of network addresses per network interface card.

22. The computer readable medium of claim 20, wherein said probability increases with each subsequent intermediate node or endpoint to which said response message is sent.

23. The computer readable medium of claim 14, wherein said connecting step comprising:
connecting said first endpoint to a first relay node; and
connecting said second endpoint to a second relay node.

24. The computer readable medium of claim 23, further comprising:
connecting said first relay node directly to said second relay node.

25. The computer readable medium of claim 23, further comprising:
connecting said first relay node indirectly to said second relay node via one or more additional relay nodes.

26. The computer readable medium of claim 14, wherein said transferring step comprises:
generating a message at at least one of said first or second endpoints for delivery through said network; and
modifying a default value in said message's time to live field by an arbitrary amount, such that intermediate nodes or endpoints receiving said message can not infer a source of said message.

27. Apparatus comprising:
means for connecting first and second endpoints to at least one relay node in a network; and
means for transferring data from said first endpoint to said second endpoint through said at least one relay node such that said first and second endpoints are not aware of an ultimate source or destination of said transferred data.

28. The apparatus of claim 27, further comprising:
means for generating a message at at least one of said first or second endpoints for delivery through said network; and
means for modifying a default value in said message's time to live field by an arbitrary amount, such that intermediate nodes or endpoints receiving said message can not infer a source of said message.
